(19) United States
(12) Patent Application Publication
(10) Pub. No.: US 2013/0048281 A1
(43) Pub. Date: Feb. 28, 2013

(54) Wellbore servicing fluids and methods of making and using same

(71) Applicants: Ryan VAN ZANTEN, Spring, TX (US); Per-Bjarte TANCHE-LARSEN, Sandnes (NO)

(72) Inventors: Ryan VAN ZANTEN, Spring, TX (US); Per-Bjarte TANCHE-LARSEN, Sandnes (NO)

(73) Assignee: HALLIBURTON ENERGY SERVICES, INC., Houston, TX (US)

(21) Appl. No.: 13/218,258

(22) Filed: Aug. 25, 2011

(51) Int. Cl. E21B 43/04; C09K 8/50

(52) U.S. Cl. 166/278; 507/209; 507/246; 507/260; 507/261; 507/266; 507/221; 507/244; 507/252; 507/265; 507/240; 507/235

(57) ABSTRACT

A method of servicing a wellbore comprising placing a composition comprising a microemulsion surfactant and a completion fluid into a wellbore, wherein the composition is substantially free of an organic solvent. A method of servicing a wellbore having a permeable zone comprising introducing a composition comprising a brine and a microemulsion surfactant to the wellbore proximate to the permeable zone wherein at least a portion of the composition enters the permeable zone and wherein the composition excludes an organic solvent. A wellbore servicing fluid comprising a microemulsion surfactant and a completion fluid.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present disclosure generally relates to wellbore servicing fluids and methods of making and using same. More particularly, this disclosure relates to servicing fluids (e.g., aqueous-based fluids) for use in surfactant and stimulation treatments, for example during wellbore completion operations.

### BACKGROUND

Natural resources such as gas, oil, and water residing in a subterranean formation or zone are usually recovered by drilling a wellbore down to the subterranean formation while circulating a drilling fluid in the wellbore. After terminating the circulation of the drilling fluid, a string of pipe, e.g., casing, is run in the wellbore. The drilling fluid is then usually circulated downward through the interior of the pipe and upward through the annulus, which is located between the exterior of the casing and the walls of the wellbore. After the drilling is terminated, a string of pipe (e.g., casing) is run in the wellbore. Next, primary cementing is typically performed whereby a cement slurry is placed in the annulus and permitted to set into a hard mass, thereby attaching the string of pipe to the walls of the wellbore and sealing the annulus. Subsequent secondary cementing operations such as squeeze cementing may also be performed.

Fluids introduced to the wellbore when completing the reservoir section of the wellbore are collectively termed completion fluids. Generally, fluids used in servicing a wellbore may be lost to the subterranean formation while circulating the fluids in the wellbore, for example during completion operations such as perforating or running screens. These fluids (or a component or filtrate thereof) may enter the subterranean formation via various types of leak-off flow paths. Completion fluids often include additives (e.g., fluid loss additives) designed to minimize the loss of these fluids to these leak-off flow paths however, there is still a significant amount of fluid filtrate that penetrates near the wellbore region. The fluid filtrate that enters the leak-off flow paths may cause damage to the formation in the form of emulsion and/or water-blockages.

Typically, following completion operations stimulation treatments, designed to improve oil and/or gas recovery are carried out. Stimulation treatments involve the use of expensive special equipment and stimulation fluids and delay the time to production.

Thus, there exists a need for a method of reducing the detrimental effects of a fluid filtrate on the formation. It would also be desirable to develop a method of reducing the costs associated with stimulating a wellbore to improve oil and/or gas recovery.

### SUMMARY

Disclosed herein is a method of servicing a wellbore comprising placing a composition comprising a microemulsion surfactant and a completion fluid into a wellbore, wherein the composition is substantially free of an organic solvent.

Also disclosed herein is a method of servicing a wellbore having a permeable zone comprising introducing a composition comprising a brine and a microemulsion surfactant to the wellbore proximate to the permeable zone wherein at least a portion of the composition enters the permeable zone and wherein the composition excludes an organic solvent.

Further disclosed herein is a wellbore servicing fluid comprising a microemulsion surfactant and a completion fluid.

Further disclosed herein is a method of servicing a wellbore comprising drilling a wellbore into a subterranean formation, introducing to the subterranean formation a wellbore servicing fluid comprising at least one oleaginous component, running a casing in the wellbore, and installing a gravel pack into the wellbore wherein the gravel pack is carried to the formation in the form of a slurry comprising a carrier fluid, a microemulsion surfactant, and gravel.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1 is a plot of the permeability of samples from Example 1.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are wellbore servicing fluids comprising a completion fluid and a microemulsion surfactant. Herein, a microemulsion surfactant refers to a surfactant that is able to form an oil-in-water emulsion (microemulsion) upon contacting with an oleaginous fluid. Oleaginous fluids herein refer to oil-based drilling or servicing fluids, invert emulsions, servicing fluids, hydrocarbons, organic liquids, and the like comprising substantially no aqueous component. Wellbore servicing fluids of the type disclosed herein may be introduced to the wellbore when completing the reservoir section of the wellbore and at least a portion of the fluid, the fluid filtrate, enter permeable zones within the formation. The fluid filtrate within the permeable zones may contact one or more naturally-occurring oleaginous fluids and/or oleaginous fluids that were introduced to the formation as a result of preceding wellbore servicing operations. Upon contact with the oleaginous fluid, the fluid filtrate may spontaneously form a microemulsion within the permeable zone, i.e., in situ, and function to (1) reduce the damage to a formation as a result of fluid loss to permeable zones and (2) stimulate the recovery of a hydrocarbon resource from the wellbore. Wellbore servicing fluids comprising a completion fluid and a microemulsion surfactant are hereinafter termed stimulating completion fluids (SCF).

In an embodiment the SCF comprises a microemulsion surfactant that is able to form a microemulsion upon contacting with an oleaginous fluid. Examples of oleaginous fluids include without limitation olefins, internal olefin based oils, mineral oil, kerosene, diesel oil, fuel oil, synthetic oil, linear or branched paraffins, esters, acetals, mixtures of crude oil, derivatives thereof, or combinations thereof. Microemulsions are thermodynamically stable mixtures of oil, water (e.g., brine), and surfactant. In contrast to conventional emulsions, microemulsions of this disclosure form spontaneously or almost spontaneously upon contacting of the components under low shear conditions which are in contrast to the conditions generally used in the formation of conventional emulsions.

Without intending to be limited by theory, in order for an emulsion to form spontaneously or almost spontaneously upon contacting of the components, there has to be a reduction in the free energy of the system. This reduction in free energy is brought about by an increase in conformational entropy, a reduction in surface tension, and a decrease in curvature energy. The free energy change of a system is represented by the following equation 1 or 2:

ΔG=ΔH−T ΔS Equation 1

ΔG=ΔAγ_{ow}−TΔS Equation 2

where G is the Gibbs free energy, T is the temperature, S is the entropy, A is the interfacial area, and γ is the interfacial tension at the oil-water interface. The entropy is increased by the creation of several small droplets, however, the creation of these droplets also causes a large increase in the oil/water interfacial area. The amount of surface area created is enormous and generating a large energy penalty from contacting oil/water. This energy penalty must be reduced by the addition of surfactants which lower the interfacial tension, thus reducing the amount of energy to form an interface. Generally emulsification is a non-spontaneous process such that ΔAγ_{ow}>>TΔS. However, the amount of thermodynamic energy required to create the new interface (ΔAγ_{ow}) is small when compared with the amount of energy that is required to form a conventional emulsion. The additional energy required is due to the interfacial curvature. The energy required to change the interfacial curvature can be represented by the following equation 3:

F=∫dA{(κ/2)(c₁+c₂−2c₀)²−κc₁c₂}+NkTf(φ) Equation 3

where κ is the bending modulus, κ is the Gaussian modulus, c₁ and c₂ are the radii of curvature, c₀ is the spontaneous curvature and NkTf(φ) is entropic in origin. The addition of a co-surfactant to the system reduces the κ term, thus reducing the energy required to produce a curved surfactant film at the oil/water interface. As used herein, a “co-surfactant” refers to a compound that participates in aggregation of molecules into a micelle but does not aggregate on its own. Generally, co-surfactants are hydrophobic materials that synergistically act with the surfactant to reduce the interfacial tension between two liquids.

A microemulsion surfactant suitable for use in the present disclosure is any surfactant capable of forming a microemulsion alone or in combination with a co-surfactant. Examples of microemulsion surfactants suitable for use in the present disclosure include, but are not limited to, non-ionic, anionic, cationic and amphoteric surfactants, derivatives thereof, or combinations thereof.

In an embodiment, the microemulsion surfactant is a non-ionic surfactant. Non-ionic surfactants suitable for use in the present disclosure include, but are not limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both, polypropylene oxide/polyethylene oxide diblock or triblock copolymers, derivatives thereof, or combinations thereof. The term “derivative,” as used herein refers to any compound that is made from one of the identified compounds, for example, by replacing one atom in the listed compound with another atom or group of atoms, or rearranging two or more atoms in the listed compound.

In an embodiment, the microemulsion surfactant is an anionic surfactant. Herein, an anionic surfactant has a negatively charged head and a hydrophobic tail comprising a carbon chain. An anionic surfactant suitable for use in this disclosure may have carbon chain having a length of from about 8 to about 24, alternatively from about 8 to about 18, alternatively from about 12 to about 22, alternatively from about 18 to about 24. Examples of anionic surfactants suitable for use in this disclosure include without limitation alkali salts of acids, alkali salts of fatty acids, alkaline salts of acids, sodium salts of acid, sodium salts of fatty acid, alkyl sulphates, alkyl ethoxylate, sulphates, sulfonates, soaps, or a combination thereof. In an embodiment, the anionic surfactant comprises sodium oleate, sodium stearate, sodium dodecylbenzenesulfonate, sodium myristate, sodium laurate, sodium decanoate, sodium caprylate, sodium cetyl sulfate, sodium myristyl sulfate, sodium lauryl sulfate, sodium decyl sulfate, sodium octyl sulfate, derivatives thereof or combinations thereof.

In an embodiment, the microemulsion surfactant is a cationic surfactant. Cationic surfactants suitable for use in the present disclosure include, but are not necessarily limited to, arginine methyl esters, alkanolamines, alkylenediamides, alkyl ester sulfonates, alkyl ether sulfonates, alkyl ether sulfates, alkali metal alkyl sulfates, alkyl or alkylaryl sulfonates, sulfosuccinates, alkyl or alkylaryl disulfonates, alkyl disulfates, alcohol polypropoxylated and/or polyethoxylated sulfates, taurates, amine oxides, alkylamine oxides, ethoxylated amides, alkoxylated fatty acids, alkoxylated alcohols, ethoxylated fatty amines, ethoxylated alkyl amines, quaternary ammonium compounds, alkyl propoxy-ethoxysulfonate, alkyl propoxy-ethoxysulfate, alkylaryl-propoxy-ethoxysulfonate, derivatives thereof, or combinations thereof.

In an embodiment the microemulsion surfactant is an amphoteric surfactant. Amphoruc surfactants suitable for use in the present disclosure include without limitation amine oxides, sultaines, amino acids, imino acids, or combinations thereof.

Specific microemulsion surfactants suitable for use in the present disclosure may include, but are not limited to, polyoxyethylene sorbitan monopalmitate, polyoxyethylene sorbitan monostearate, polyoxyethylene sorbitan monooleate, linear alcohol alkoxylates, alkyl ether sulfates, dodecylbenzene sulfonic acid, linear nonyl-phenols, dioxane, ethylene oxide, polyethylene glycol, ethoxylated castor oils, dipalmitoyl-phosphatidylcholine, sodium 4-(1′ heptylnonyl) benzenesulfonate, polyoxyethylene nonyl phenyl ether, sodium dioctyl sulphosuccinate, tetraethyleneglycoldodecylether, sodium octlylbenzenesulfonate, sodium hexadecyl sulfate, sodium laureth sulfate, ethylene oxide, decylamine oxide, dodecylamine betaine, dodecylamine oxide, zwitterionic phospholipids, derivatives thereof, or combinations thereof. In one non-limiting embodiment at least two surfactants in a blend may be used to create a single phase microemulsion in-situ. Suitable microemulsion surfactants may also include surfactants containing a non-ionic spacer-arm central extension and an ionic or nonionic polar group. The non-ionic spacer-arm central extension may be the result of polypropoxylation, polyethoxylation, or a mixture of the two, in non-limiting embodiments.

In an embodiment, the microemulsion surfactant is present in the SCF in an amount of from about 0.01 wt. % to about 50 wt. %; alternatively from about 0.1 wt. % to about 50 wt. %; or alternatively from about 1 wt. % to about 50 wt. % based on the total weight of the SCF.

In an embodiment, the SCF further comprises a co-surfactant. Co-surfactants suitable for use in the present disclosure include, but are not limited to, alcohols, glycols, phenols, thiols, carboxylates, sulfonates, pyrollidones, any derivative thereof, and any combination thereof. In an embodiment, an alcohol useful as a co-surfactant may have from about 3 to about 10 carbon atoms. In an embodiment, suitable alcohols can include, but are not limited to, t-butanol, n-butanol, n-pentanol, n-hexanol, 2-ethyl-hexanol, propanol, and sec-butanol. Suitable glycols can include, but are not limited to, ethylene glycol, polyethylene glycol, propylene glycols, and triethylene glycol. In an embodiment, a co-surfactant may be present in the SCF in an amount of from about 0.01 wt. % to about 50 wt. %; alternatively from about 0.1 wt. % to about 50 wt. %; or alternatively from about 0.01 wt. % to about 25 wt. % based on the total weight of the SCF.

In an embodiment, the SCF comprises an aqueous-based completion fluid. Herein, an aqueous-based completion fluid refers to a completion fluid having equal to or less than about 20 vol. %, 15 vol. %, 10 vol. %, 5 vol. %, 2 vol. %, or 1 vol. % of a non-aqueous fluid based on the total volume of the SCF. Any completion fluid suitable for use in a completion operation may be employed in the present disclosure. In an embodiment, the completion fluid is a low solids fluid having a density, chemical composition, and flow characteristics compatible with the formation to which it is introduced. In some embodiments, the completion fluid is a solids-free fluid comprising less than about 5 wt. %, 4 wt. %, 3 wt. %, 2 wt. % or 1 wt. % solids based on the total weight of the SCF.

In an embodiment, the completion fluid comprises a brine. Brines are aqueous fluids that are typically saturated or nearly saturated with salt. Examples of brines suitable for use in this disclosure include without limitation saturated or partially saturated aqueous solutions comprising halide-containing salts, alkali metal salts, alkaline metal salts, formate-containing compounds, sodium bromide (NaBr), calcium chloride (CaCl₂), calcium bromide (CaBr₂), sodium chloride (NaCl), potassium chloride (KCl), ammonium chloride (NH₄Cl), zinc bromide (ZnBr₂), ethyl formate, sodium formate, cesium formate, potassium formate, methyl formate, methyl chloro formate, triethyl orthoformate, trimethyl orthoformate, derivatives thereof, or combinations thereof. The choice of brine may be dictated by a variety of factors such as the formation condition and the desired density of the resulting solution.

In an embodiment, the completion fluid comprises a gravel packing fluid. Gravel packing treatments are used, inter alia, to reduce the migration of unconsolidated formation particulates (e.g., sand and fines) into the wellbore. In gravel packing operations, particulates, referred to as gravel, are carried to a wellbore in a subterranean producing zone by a servicing fluid known as carrier fluid. That is, the particulates are suspended in a carrier fluid, which may be viscosified, and the carrier fluid is pumped into a wellbore in which the gravel pack is to be placed. As the particulates are placed in the zone, the carrier fluid leaks off into the subterranean zone and/or is returned to the surface. The resultant gravel pack acts as a filter to separate formation solids from produced fluids while permitting the produced fluids to flow into and through the wellbore. When installing the gravel pack, the gravel is carried to the formation in the form of a slurry by mixing the gravel with a viscosified carrier fluid. Such gravel packs may be used to stabilize a formation while causing minimal impairment to well productivity. The gravel, inter alia, acts to prevent the particulates from occluding the screen or migrating with the produced fluids, and the screen, inter alia, acts to prevent the gravel from entering the wellbore. In an embodiment, the SCF comprises a carrier fluid, a micoremulsion surfactant, an optional cosurfactant, and gravel.

In an embodiment, the completion fluid comprises a perforating fluid. Herein, a perforating fluid refers to a specially prepared solids-free fluid placed in the wellbore over the interval to be perforated. In an embodiment, the perforation fluid comprises a completion brine of the type previously described herein.

In an embodiment, the completion fluid comprises a workover fluid. Herein, a workover fluid refers to a well-control fluid that is used during workover operations. In an embodiment, the workover fluid comprises a completion fluid of the type previously described herein.

In an embodiment, the completion fluid comprises a fluid loss pill. Alternatively the completion fluid is a fluid loss pill. Herein, a fluid loss pill refers to a composition containing a viscosified completion brine that is introduced to a formation to reduce the loss of fluids to a formation.

In an embodiment, the completion fluid comprises one or more additives to improve the properties of the fluids. For example, the completion fluid may comprise a fluid loss control additive. Any suitable fluid loss control additive may be used, for example polymer fluid loss control additives, particulate fluid loss control additives, or combinations thereof. Examples of suitable fluid loss control additives are disclosed in U.S. Pat. Nos. 5,340,860, 6,626,992, 6,182,758, each of which is incorporated by reference herein in its entirety.

Other additives which may be included in the completion fluid include without limitation corrosion inhibitors, shale stabilizers, oxygen scavengers, biocides, defoamers and the like. Additives to improve the properties of the completion fluids may be included singularly or in combination and in amounts effective to meet one or more user and/or process needs.

In an embodiment an SCF of the type disclosed herein excludes or is substantially free of an organic solvent. Nonlimiting examples of organic solvents include aromatic, cyclic, linear liquid hydrocarbons, chlorinated hydrocarbons and ethers. Herein, an SCF that is substantially free of an organic solvent refers to an SCF containing less than about 20 vol. %, 15 vol. %, 10 vol. %, 5 vol. %, 2 vol. % or 1 vol. % organic solvent based on the total volume of the SCF.

The components of the SCF may be combined in any order desired by the user to form a fluid that may then be placed into a wellbore. The components of the SCF may be combined using any mixing device compatible with the composition, for example a bulk mixer or a recirculating mixer.

In an embodiment, a method of servicing a wellbore comprises drilling a wellbore in a subterranean formation and introducing to the subterranean formation a wellbore servicing fluid (e.g., drilling fluid, conditioning fluid, circulating fluid, etc.) that comprises at least one oleaginous fluid. Introduction of the oleaginous fluid to the wellbore may result in the formation of oil-wet areas within the formation. It is to be understood that “subterranean formation” encompasses both areas below exposed earth and areas below earth covered by water such as ocean or fresh water. In some embodiments, after drilling, the method further comprises running a casing in the wellbore and securing the casing into position against the subterranean formation using a sealant composition (e.g., cement).

After drilling and/or casing the wellbore, a completion operation is performed to prepare the wellbore to produce hydrocarbons. That is, the completion operation may be performed on a cased or un-cased (e.g., open hole) wellbore. The completion operation may include first perforating the subterranean formation by introducing a perforating fluid into the wellbore and jetting the perforating fluid from the wellbore to the subterranean formation thereby forming perforation tunnels within the subterranean formation. Alternatively, the perforations may be formed via operation of a perforating gun (e.g., explosive, shaped charges). In an embodiment, the SCF is placed in the well to facilitate final operations prior to initiation of production, such as setting screens, production liners, packers, downhole valves or shooting perforations into the producing zone. The SCF is meant to control a well should downhole hardware become functionally compromised, without damaging the producing formation or completion components.

In an embodiment, an SCF of the type disclosed herein when introduced to a wellbore may function as a completion fluid that balances the formation pressure and displaces drilling mud from the wellbore. It is contemplated that at least a portion of the SCF introduced to the wellbore is lost to permeable zones and enters the surrounding formation as a filtrate. Examples of such permeable zones include fissures, cracks, fractures, streaks, flow channels, voids, high permeability streaks, annular voids, or combinations thereof. The permeable zones may be present in the cement column residing in the annulus, a wall of the conduit in the wellbore, a microannulus between the cement column and the subterranean formation, and/or a microannulus between the cement column and the conduit. The filtrate that enters the permeable zones may contact an oleaginous fluid naturally present in the wellbore and/or an oleaginous fluid that was introduced to the wellbore during a wellbore servicing operation. The filtrate upon contact with the oleaginous fluid may spontaneously form a microemulsion and thereby facilitate the wellbore servicing operation (e.g., stimulate hydrocarbon production) by emulsifying any hydrocarbon encountered in the permeable zone resulting the removal of emulsion blockages. Additionally, the filtrate that enters the permeable zone may facilitate the wellbore servicing operation by aggressively water-wetting the formation resulting in capillary forces that remove water blocks and stimulate production of oil and/or gas. An SCF of the type disclosed herein may provide additional advantages in that the SCF is substantially free of or excludes an organic solvent. The absence of an organic solvent may reduce detrimental effects of the SCF on the formation and provide an environmentally friendly alternative to fluids containing an organic solvent.

In an embodiment, an SCF of the type disclosed herein when introduced to subterranean formation may increase the productivity of the formation by greater than about 1%; alternatively greater than about 10%; or alternatively greater than about 50%. Herein, the productivity refers to the amount of a desirable natural resource recovered from the wellbore.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims in any manner.

### Example 1

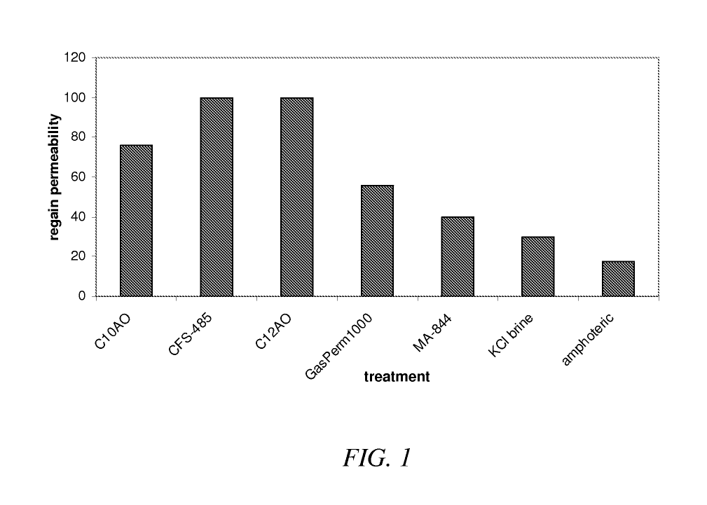

The effect of an SCF of the type disclosed herein on the permeability of a sample formation was investigated. Initial permeability of the dry cores was determined by flowing nitrogen through the cores. The cores were then saturated in the different treatment fluids and gas was then run through the cores again. The permeability of the cores was found using Darcy's Law, and the permeability after damage with the aqueous phase was divided by the initial permeability to give percentage regain. Specifically, seven Crab Orchard Sand sandstone cores, designated cores 1-7, were treated with the indicated fluids and the permeability of the core determined after treatment. Core 1 was treated with a mixture of decylamine oxide and pyrollidone; core 2 was treated with a mixture of dodecylamine betaine and butanol; core 3 was treated with dodecylamine oxide; core 4 was treated with GASPERM 1000; core 5 was treated with MA-844; core 6 was treated with a KCl brine; and core 7 was treated with an amphoteric surfactant. GASPERM 1000 service is a service to help control fracture face damage and boost production from unconventional gas reservoirs commercially available from Halliburton Energy Services. MA-844 is a is a service to help control fracture face damage and boost production from unconventional gas reservoirs commercially available from Halliburton Energy Services. The results of the test are shown in FIG. 1. The results demonstrate that cores treated with SCFs of the type disclosed herein (cores 1-3) were more permeable than those cores treated with materials containing an organic solvent.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k* (R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure. The discussion of a reference is not an admission that it is prior art to the present disclosure, especially any reference that may have a publication date after the priority date of this application. The disclosures of all patents, patent applications, and publications cited herein are hereby incorporated by reference, to the extent that they provide exemplary, procedural, or other details supplementary to those set forth herein.

What is claimed is:

1. A method of servicing a wellbore comprising:
placing a composition comprising a microemulsion surfactant and a completion fluid into a wellbore;
wherein the composition is substantially free of an organic solvent.

2. The method of claim 1 wherein the microemulsion surfactant comprises non-ionic surfactants, anionic surfactants, cationic surfactants, amphoteric surfactants, derivatives thereof, or combinations thereof.

3. The method of claim 2 wherein the non-ionic surfactants comprise alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated, polypropylene oxide/polyethylene oxide diblock or triblock copolymers derivatives thereof, or combinations thereof.

4. The method of claim 2 wherein the cationic surfactants comprise arginine methyl esters, alkanolamines, alkylenediamides, alkyl ester sulfonates, alkyl ether sulfonates, alkyl ether sulfates, alkali metal alkyl sulfates, alkyl or alkylaryl sulfonates, sulfosuccinates, alkyl or alkylaryl disulfonates, alkyl disulfates, alcohol polypropoxylated and/or polyethoxylated sulfates, taurates, amine oxides, alkylamine oxides, ethoxylated amides, alkoxylated fatty acids, alkoxylated alcohols, ethoxylated fatty amines, ethoxylated alkyl amines, quaternary ammonium compounds, alkyl propoxy-ethoxysulfonate, alkyl propoxy-ethoxysulfate, alkylaryl-propoxy-ethoxysulfonate, derivatives thereof, or combinations thereof.

5. The method of claim 1 wherein the microemulsion surfactant comprise polyoxyethylene sorbitan monopalmitate, polyoxyethylene sorbitan monostearate, polyoxyethylene sorbitan monooleate, linear alcohol alkoxylates, alkyl ether sulfates, dodecylbenzene sulfonic acid, linear nonyl-phenols, dioxane, ethylene oxide, polyethylene glycol, ethoxylated castor oils, dipalmitoyl-phosphatidylcholine, sodium 4-(1′ heptylnonyl) benzenesulfonate, polyoxyethylene nonyl phenyl ether, sodium dioctyl sulphosuccinate, tetraethyleneglycoldodecylether, sodium octlylbenzenesulfonate, sodium hexadecyl sulfate, sodium laureth sulfate, ethylene oxide, decylamine oxide, dodecylamine oxide, zwitterionic phospholipids, derivatives thereof, or combinations thereof.

6. The method of claim 2 wherein the anionic surfactants have a carbon chain having a length of from about 8 to about 24.

7. The method of claim 2 wherein the anionic surfactants comprise alkali salts of acids, alkali salts of fatty acids, alkaline salts of acids, sodium salts of acid, sodium salts of fatty acid, alkyl sulphates, alkyl ethoxylate, sulphates, sulfonates, soaps, or a combination thereof.

8. The method of claim 2 wherein the anionic surfactants comprise sodium oleate, sodium stearate, sodium dodecylbenzenesulfonate, sodium myristate, sodium laurate, sodium decanoate, sodium caprylate, sodium cetyl sulfate, sodium myristyl sulfate, sodium lauryl sulfate, sodium decyl sulfate, sodium octyl sulfate, derivatives thereof or combinations thereof.

9. The method of claim 1 wherein the microemulsion surfactant is present in the composition in an amount of from about 0.01 wt. % to about 50 wt. % based on the total weight of the composition.

10. The method of claim 1 wherein the composition further comprises a co-surfactant.

11. The method of claim 10 wherein the co-surfactant comprises alcohols, glycols, phenols, thiols, carboxylates, sulfonates, pyrollidones, derivatives thereof, or combinations thereof.

12. The method of claim 11 wherein the co-surfactant comprises an alcohol having from about 3 to about 10 carbon atoms.

13. The method of claim 11 wherein the alcohol comprises t-butanol, n-butanol, n-pentanol, n-hexanol, 2-ethyl-hexanol, propanol, sec-butanol, or combinations thereof.

14. The method of claim 11 wherein the glycol comprises ethylene glycol, polyethylene glycol, propylene glycols, triethylene glycol, or combinations thereof.

15. The method of claim 10 wherein the co-surfactant is present in the composition in an amount of from about 0.01 wt. % to about 25 wt. %.

16. The method of claim 1 wherein the completion fluid comprises a brine, a gravel-packing fluid, fluid loss pill, peforating fluid, or workover fluid.

17. The method of claim 1 wherein a productivity of the formation is increased by greater than about 1% after introduction of the composition.

18. A method of servicing a wellbore having a permeable zone comprising:
introducing a composition comprising a brine and a microemulsion surfactant to the wellbore proximate to the permeable zone wherein at least a portion of the composition enters the permeable zone and wherein the composition excludes an organic solvent.

19. The method of claim 18 wherein the microemulsion surfactant comprises non-ionic surfactants, anionic surfactants, cationic surfactants, amphoteric surfactants, derivatives thereof, or combinations thereof.

20. A wellbore servicing fluid comprising a microemulsion surfactant and a completion fluid.

21. A method of servicing a wellbore comprising:
drilling a wellbore into a subterranean formation;
introducing to the subterranean formation a wellbore servicing fluid comprising at least one oleaginous component;
running a casing in the wellbore; and
installing a gravel pack into the wellbore wherein the gravel pack is carried to the formation in the form of a slurry comprising a carrier fluid, a microemulsion surfactant, and gravel.
